(19) United States
(12) Patent Application Publication
(10) Pub. No.: US 2023/0222501 A1
(43) Pub. Date: Jul. 13, 2023

(54) AUTHENTICATION CARD DEGRADATION SECURITY

(71) Applicant: International Business Machines Corporation, Armonk, NY (US)

(72) Inventors: Rinkesh I. Bansal, Pune (IN); Vinod A. Valecha, Pune (IN); Sanjay B. Panchal, Mumbai (IN); Chintan Thaker, Pune (IN)

(21) Appl. No.: 17/571,831

(22) Filed: Jan. 10, 2022

(51) Int. Cl. G06Q 20/40; G06Q 20/38; G06Q 20/36

(52) U.S. Cl. CPC G06Q 20/401; G06Q 20/389; G06Q 20/382; G06Q 20/3674

(57) ABSTRACT

A first access attempt to perform a secure transaction is received, from a first user. The secure transaction is related to an authentication card that has a physical exterior. An authentication card profile related to the authentication card of the first user is retrieved based on the first access attempt. The authentication card profile describes a set of one or more degradation characteristics, each degradation characteristic of the set of degradation characteristics describes a degradation of the physical exterior of the authentication card. A validation status of the authentication card is determined. The determination is based on the first access attempt and on the set of degradation characteristics. A security response related to the first access attempt is performed in response to the validation status.

### BACKGROUND

The present disclosure relates to security, and more specifically, to authenticating an access attempt through physical degradation.

Authentication of secure transactions may be performed in part with authentication cards. Authentication cards may include information such as serial numbers tied to a user that is attempting to perform a given transaction. The security of an authentication card may be compromised if the included information is compromised.

### SUMMARY

According to embodiments, disclosed are a method, system, and computer program product.

A first access attempt to perform a secure transaction is received, from a first user. The secure transaction is related to an authentication card that has a physical exterior. An authentication card profile related to the authentication card of the first user is retrieved based on the first access attempt. The authentication card profile describes a set of one or more degradation characteristics, each degradation characteristic of the set of degradation characteristics describes a degradation of the physical exterior of the authentication card. A validation status of the authentication card is determined. The determination is based on the first access attempt and on the set of degradation characteristics. A security response related to the first access attempt is performed in response to the validation status.

The above summary is not intended to describe each illustrated embodiment or every implementation of the present disclosure.

### BRIEF DESCRIPTION OF THE DRAWINGS

The drawings included in the present application are incorporated into, and form part of, the specification. They illustrate embodiments of the present disclosure and, along with the description, serve to explain the principles of the disclosure. The drawings are only illustrative of certain embodiments and do not limit the disclosure.

FIG. 1 depicts the representative major components of an example computer system that may be used, in accordance with some embodiments of the present disclosure;

FIG. 2 depicts a cloud computing environment according to an embodiment of the present invention;

FIG. 3 depicts abstraction model layers according to an embodiment of the present invention;

FIG. 4A depicts an authentication card of a system configured to perform degradation security, consistent with some embodiments of the disclosure;

FIG. 4B depicts a system configured to perform degradation security, consistent with some embodiments of the disclosure; and

FIG. 5 depicts an example method of authenticated transactions, consistent with some embodiments of the disclosure.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention.

### DETAILED DESCRIPTION

Aspects of the present disclosure relate to security; more particular aspects relate to authenticating an access attempt through physical degradation. While the present disclosure is not necessarily limited to such applications, various aspects of the disclosure may be appreciated through a discussion of various examples using this context.

Authentication of secure transactions may be performed in part with authentication cards (“Auth cards”). Authentication cards may be cards that include information. The included information may be used to perform transactions. Auth cards may be made of a material, such as a composite, metal, and/or plastic. The included information may be in a human-readable format, such as roman numerals, English text, and the like. The included information may be in a machine-readable format, such as a barcode or matrix barcode. The included information may be stored on the surface of the card, such as markings or symbols (e.g., text, characters, written or printed signatures, or other relevant visual values). The included information may be stored in a magnetic strip. The included information may be stored in an integrated circuit embedded into the card, such as a smart card.

Authentication cards have many advantages that have increased usage and fields of use. Specifically, auth cards are relatively small and built of various inexpensive materials, may be inexpensively produced, and easily distributed. In many normal every-day scenarios, people carry auth cards for performing simple transactions. For instance, a user may access a gym with an identification card that has identification information printed on it. In another instance, a user may purchase goods from a merchant using a payment card with a magnetic strip that contains purchase information (e.g., a credit card number). In yet another instance, an employee may securely enter a facility of an employer every day for work. The employee may have a smart card with an embedded circuit and a badge or card reader may be tied to the door locks and/or personal computers that are used by the employee.

Authentication cards may store information such as serial numbers or other information tied to a user that is attempting to perform a transaction. For instance, an employee passcode may be stored by an auth card. In some circumstances, multi-factor security may be performed by an auth card. For instance, an auth card may store a user's public key and a personal identification number (“PIN”) for authenticating financial transactions.

The security of an authentication card may be compromised if the information that is included with the auth card is obtained by a third party. Specifically, the original user of an auth card does not know that card is compromised.

In a first instance, a malicious third party may clone the included data of the card and create a duplicate card. This may be performed with a card reader and a malicious party that has access to the authentication card. For example, an original user may attempt to pay for parking at a sporting event with a malicious third party that identifies as a parking attendant. The original user may swipe their payment card through a card reader associated with the malicious third party. Later, the malicious third party may obtain and create a fake or duplicate of the payment card.

In a second instance, a malicious third party may obtain the information that is associated with the authentication card from another source. For example, a malicious third party may utilize a computer or physical intrusion technique, such as computer hacking or breaking and entering, to obtain access to one or more stored account details of various users. The malicious third party may either create fake or duplicate auth cards or may sell them in an illicit marketplace. In situations like this, an original user of an auth card may not even have used or attempted to use the auth card when the malicious third party intercepted or obtained the included information.

Some methods may exist to mitigate the security issues of authentication cards, but these existing methods may have drawbacks. Users may be prompted to provide a second factor of authentication when they attempt to perform a transaction, but this can be cumbersome. For instance, users may be forced to memorize and provide some sort of arbitrary information such as a secondary personal identification number. Another existing method is one in which a user may be prompted to provide personal details about themselves, such as answering a security question. The security question may be easier to memorize, but it may also expose a user's personal information to other security risks. For instance, a user may provide their mother's maiden name as an answer to a security question for accessing a membership account. If the account information of the membership account is compromised, this personal information may then be used to compromise other accounts of the user. Another method of security is to provide a two-factor token to the user. A two-factor token may be a secondary electronic device that generates a code that changes regularly (e.g., every thirty seconds). This may also be suboptimal because a user must now remember both the auth card and also the two-factor token if they wish to perform a transaction. Yet another method of securing an auth card transaction may be to prompt a user to provide biometric data in addition to the auth card. This may be undesirable, because providing biometric data can be awkward and tedious. If a user is requested to submit to a retinal or fingerprint every time, the user may become annoyed or feel distrusted.

Authentication card degradation security (ACDS) may overcome the challenges and issues with other methods of securing auth card transactions. ACDS may authenticate a card transaction by performing multiple factor authentication directly on an auth card based on the degradation of the auth card. The ACDS may determine as to whether an auth card is valid (“validation status”) by visually inspecting the exterior of the auth card.

In some embodiments, the ACDS may determine the validation status by comparing the current state of degradation of an auth card with a stored last-known state of the auth card. For example, every time a user performs access attempts, such as entering buildings or paying for goods/services, a capture of the user's auth card may be stored and a degradation of the auth card at the time of the access attempt may be stored. Continuing the example, a captured degradation may be stored in an auth card profile associated with the user. The auth card profile may be stored by the card reader. In some embodiments, the auth card profile may be shared with other card readers, such as by being stored remotely and provided to other card readers upon each access attempt. The auth card profile may include the various external or physical characteristics of degradation (“degradation characteristics”). The auth card profile may also include changes or degradation from each previous scan.

The degradation of an auth card may include any physical change in appearance or other external characteristic or characteristics of an auth card due to exposure to an environment. A degradation characteristic may include any of the following: scratching, marring, scaling, flaking, abrasions, or scraping, due to contact with another object.

In some embodiments, only one surface, such as the front of an auth card, may be used as the basis of ACDS. In a first example, an auth card may have a front surface and a back surface, and a first degradation characteristic may be a scratch on the front surface. Continuing the first example, a second degradation characteristic may be a smudge on the front surface. In some embodiments, both the front and back of an auth card may be used as the basis of ACDS. In a second example, an auth card may have a front surface and a back surface, and a first degradation characteristic may be a scratch on the front surface. Continuing the second example, a second degradation characteristic may be a scar on the back surface.

The ACDS may determine the validation status by performing one or more relevant techniques to identify, record, and determine the degradation characteristics of an auth card. In detail, degradation characteristics of an auth card may be captured by an image capture device, such as a camera. The auth card may be analyzed using an image analysis or processing technique. The auth card may be analyzed to determine the current state of the card. The ACDS may store the degradation characteristics in the authentication card profile. The authentication card profile may then be used to determine the validation status, such as by comparing the current degradation characteristics to the stored degradation characteristics.

The ACDS may provide one or more advantages compared to other authentication cards, while also preventing the creation of a duplicate or fake card of an unaware user.

First, ACDS may operate without prompting the user for additional information. Specifically, the ACDS may operate by validating an authentication card as it is read by a card reader. As part of ACDS, the card reader may include an optical or image sensor, such as a camera, to capture an image of the card as it is being reader by the card reader. The user does not have to consider or be prompted for additional information. This may increase security as an auth card user no longer has to memorize additional factors, such as PINs or passwords or passphrases.

Another advantage of ACDS is increased privacy as compared to other methods of securing auth cards. For example, an ACDS may be registered and usable by a user without the user providing any potentially personal information, such as a security question and answer. As ACDS captures an image and determines a degradation status of a card, a user may be able to perform transactions without additional security factors (as the degradation of the auth card is the additional factors). Consequently, a user may not need to provide any personally identifiable information, such as names of relatives, places of birth. Further, using ACDS may result in biometric privacy as a transaction may be authenticated without requestion biometric information. In some embodiments, biometrics may be requested as an additional authenticating factor, in addition to the degradation of the auth card.

Yet a further advantage of ACDS is even more difficult security than other auth card systems. As the physical condition, degradation (and resultantly degradation characteristics) of an auth card occur gradually over time (e.g., weeks of use, years of use, tens or hundreds of access attempts), the degradation characteristics may gradually and continually update. Specifically, an auth card may smudge, scratch, or otherwise degrade over time, and each degradation may happen at a relatively minute level (e.g., fractions of a millimeter). With each authentication attempt, the degradation may be of a very slight difference and, consequently, the authentication factor (e.g., the degradation characteristics) may be different than previous authentication attempts (e.g., newly formed scratches, additional smudging). These ever-changing additional factors may change without any processing or computing operation. For example, the degradations may just occur on an auth card through normal use and handling in a real-world environment. The continued updating of the degradation characteristics, may also use less processing power than generating large random numbers or tokens for additional security factors. The reduced processing may allow for lower-powered processing devices and subsystem to perform authentication operations of ACDS as compared to other systems.

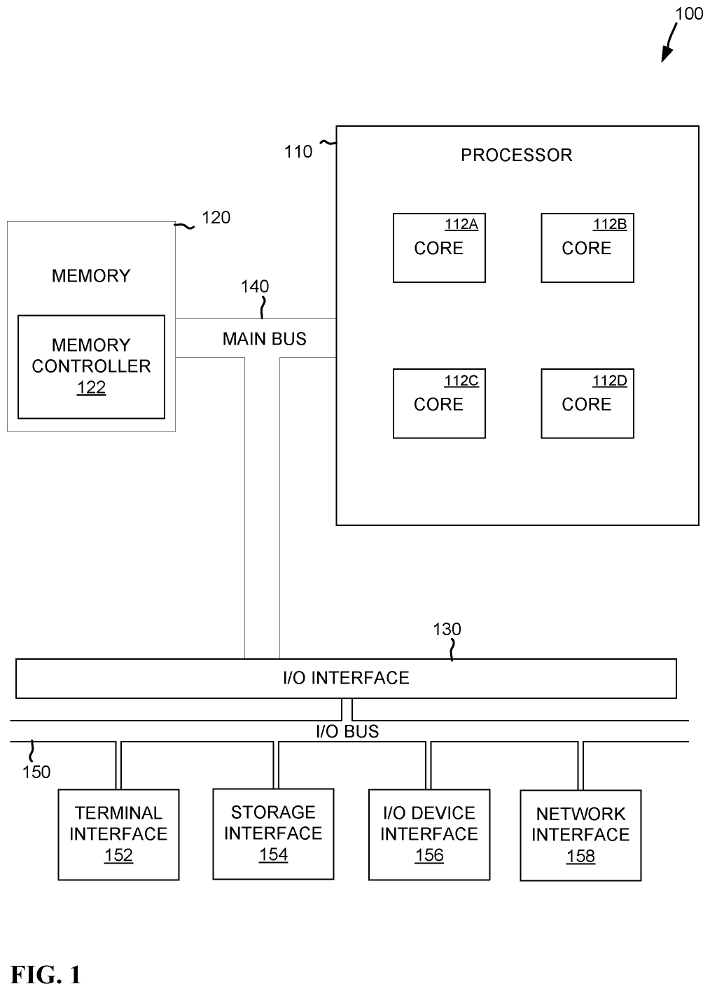

FIG. 1 depicts the representative major components of an example computer system 100 (alternatively, computer) that may be used, in accordance with some embodiments of the present disclosure. It is appreciated that individual components may vary in complexity, number, type, and/or configuration. The particular examples disclosed are for example purposes only and are not necessarily the only such variations. The computer system 100 may include a processor 110, memory 120, an input/output interface (herein I/O or I/O interface) 130, and a main bus 140. The main bus 140 may provide communication pathways for the other components of the computer system 100. In some embodiments, the main bus 140 may connect to other components such as a specialized digital signal processor (not depicted).

The processor 110 of the computer system 100 may be comprised of one or more cores 112A, 112B, 112C, 112D (collectively 112). The processor 110 may additionally include one or more memory buffers or caches (not depicted) that provide temporary storage of instructions and data for the cores 112. The cores 112 may perform instructions on input provided from the caches or from the memory 120 and output the result to caches or the memory. The cores 112 may be comprised of one or more circuits configured to perform one or more methods consistent with embodiments of the present disclosure. In some embodiments, the computer system 100 may contain multiple processors 110. In some embodiments, the computer system 100 may be a single processor 110 with a singular core 112.

The memory 120 of the computer system 100 may include a memory controller 122. In some embodiments, the memory 120 may include a random-access semiconductor memory, storage device, or storage medium (either volatile or non-volatile) for storing data and programs. In some embodiments, the memory may be in the form of modules (e.g., dual in-line memory modules). The memory controller 122 may communicate with the processor 110, facilitating storage and retrieval of information in the memory 120. The memory controller 122 may communicate with the I/O interface 130, facilitating storage and retrieval of input or output in the memory 120.

The I/O interface 130 may include an I/O bus 150, a terminal interface 152, a storage interface 154, an I/O device interface 156, and a network interface 158. The I/O interface 130 may connect the main bus 140 to the I/O bus 150. The I/O interface 130 may direct instructions and data from the processor 110 and memory 120 to the various interfaces of the I/O bus 150. The I/O interface 130 may also direct instructions and data from the various interfaces of the I/O bus 150 to the processor 110 and memory 120. The various interfaces may include the terminal interface 152, the storage interface 154, the I/O device interface 156, and the network interface 158. In some embodiments, the various interfaces may include a subset of the aforementioned interfaces (e.g., an embedded computer system in an industrial application may not include the terminal interface 152 and the storage interface 154).

Logic modules throughout the computer system 100—including but not limited to the memory 120, the processor 110, and the I/O interface 130—may communicate failures and changes to one or more components to a hypervisor or operating system (not depicted). The hypervisor or the operating system may allocate the various resources available in the computer system 100 and track the location of data in memory 120 and of processes assigned to various cores 112. In embodiments that combine or rearrange elements, aspects and capabilities of the logic modules may be combined or redistributed. These variations would be apparent to one skilled in the art.

Although this disclosure includes a detailed description on cloud computing, implementation of the teachings recited herein are not limited to a cloud computing environment. Rather, embodiments of the present invention are capable of being implemented in conjunction with any other type of computing environment now known or later developed. Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases

automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two

or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

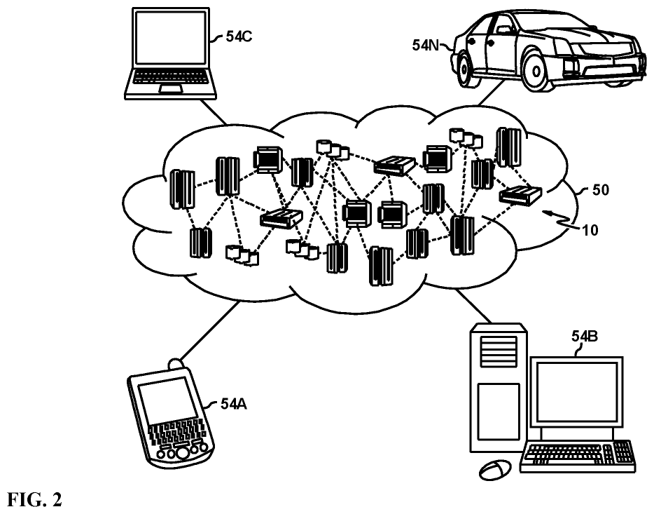

Referring now to FIG. 2, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

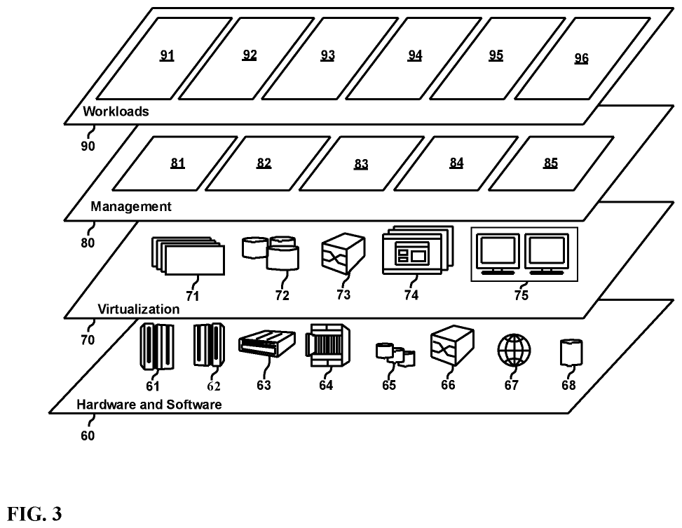

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68. Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and ACDS 96.

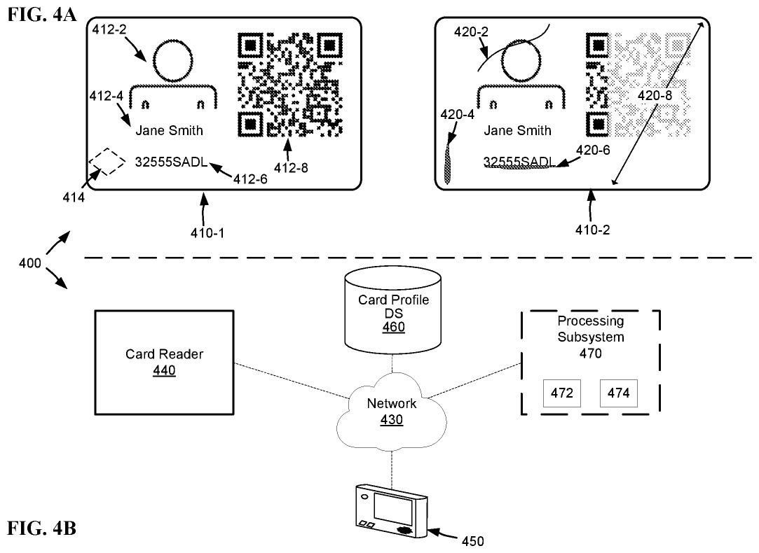

FIG. 4A depicts an authentication card 410 (depicted as authentication card 410-1 and 410-2) of a system 400, configured to perform degradation security, consistent with some embodiments of the disclosure. System 400 may be configured to perform ACDS against a variety of auth cards. For example, as depicted in FIG. 4A, auth card 410 may be a printed identification card of an employee (not depicted). In some embodiments, auth card 410 may be a magnetic strip card, identification card, a purchase card, a smart card, or any other relevant auth card that is a physical real-world object. Auth card 410 may include first stored user data 412-2, second stored user data 412-4, third stored user data 412-6, and fourth stored user data 412-8 (collectively, stored user data 412). For example, auth card 410 may be a plastic card created by an employer of company for a user that is the employee. The stored user data 412 may be information related to employment of the employee for the company, such as a photo 412-2, name 412-4, and serial number 412-6, and a passphrase 412-8 for secure access.

The stored user data 412 may be machine-readable data located on the inside or outside of the auth card 410. In a first example, a matrix bar code 412-8 may be printed on the exterior surface of the auth card 410. The matrix bar code 412-8 may contain a passphrase that is readable by a computer with a communicatively couple camera. In a second example, an integrated circuit 414 may be embedded inside the plastic of the auth card 410 and may be readable by a near field communication reader. The integrated circuit 414 may contain various information regarding employment of the user.

Auth card 410 may show a first degradation 420-2, a second degradation 420-4, a third degradation 420-6, and a fourth degradation 420-8 (collectively, degradations 420). Specifically, auth card 410 may have various characteristics as wear and tear occur to the auth card from use by the employee, that classify as degradation characteristics for performing ACDS. The first degradation 420-2 may be a scratch across the auth card 410 that covers a part of the first stored user data 412-2. The second degradation 420-4 may be a stain from debris that the auth card 410 exposed to, such as dirt or food. The third degradation 420-6 may be bleeding of the ink of the third stored user data 412-6. The bleeding may be a result of smudging or rubbing on the auth card 410 by the employee or may be a result of exposure of the card to dampness or wetness. The fourth degradation 420-8 may be a region of surface change due to exposure, such as from light, temperature, contact with a substance, and/or humidity. For example, the fourth degradation 420-8 may be an area of fading, darkening, or other discoloration due to exposure that effects the printings on the auth card 410, such as the fourth stored user data 412-8. In another example, the fourth degradation 420-8 may be an area of change, such an increase or decrease, of glossiness due to exposure that affects the coating of the auth card 410.

FIG. 4B depicts a system 400 configured to perform degradation security, consistent with some embodiments of the disclosure. System 400 may include one or more of the following: a communication network 430, a card reader 440, a biometric reader 450, a card profile datastore 460, and a processing subsystem 470.

Network 430 may be implemented using any number of any suitable physical and/or logical communications topologies. The network 430 can include one or more private or public computing networks. For example, network 430 may comprise a private network (e.g., a network with a firewall that blocks non-authorized external access) that is associated with a particular function or workload (e.g., communication, streaming, hosting, sharing), or set of software or hardware clients. Alternatively, or additionally, network 430 may comprise a public network, such as the Internet. Consequently, network 430 may form part of a data unit network (e.g., packet-based)—for instance, a local-area network, a wide-area network, and/or a global network.

Network 430 can include one or more servers, networks, or databases, and can use one or more communication protocols to transfer data between other components of system 400. Furthermore, although illustrated in FIG. 4B as a single entity, in other examples, network 430 may comprise a plurality of networks, such as a combination of public and/or private networks. The communications network 430 can include a variety of types of physical communication channels or “links.” The links can be wired, wireless, optical, and/or any other suitable media. In addition, the communications network 430 can include a variety of network hardware and software (not depicted) for performing routing, switching, and other functions, such as routers, switches, base stations, bridges or any other equipment that may be useful to facilitate communicating data.

Card reader 440 of system 400 may be a physical reader device, such as a magstripe reader, a smart card reader, a camera, or other relevant sensor communicatively coupled to a computer system, such as computer 100. Card reader 440 may be communicatively coupled to the other components of system 400 by way of network 430. Card reader 440 may be configured to read auth cards, such as auth card 410 and to authorize access based on verifying the credentials. Specifically, card reader 440 may be configured to access, such as visually, magnetically, or through a near field communication signal, stored user data of an auth card (e.g., stored user data 412 of auth card 410, data stored in integrated circuit 414 of auth card 410).

The card reader 440 may have a single physical reader, such as only one of a magstripe reader or a smart card reader. The card reader 440 may have a combination of a plurality of physical readers, such as a magstripe reader and a smart card reader. In some embodiments, card reader 440 may have, in addition to a physical reader device, a sensor to capture an image of an auth card. For example, card reader 440 may have a magstripe reader and additional an optical capture device, such as a black and white camera, to capture an image of the external surface or outer appearance of auth cards.

In some embodiments, system 400 may include a biometric reader 450. The biometric reader 450 may be a particular sensor device that is communicatively coupled to the other components of system 400 by network 430. The biometric reader 450 may be a reader configured to capture a general biometric aspect of a user. For example, biometric reader 450 may be a camera configured to capture a picture of the entirety of a user from top to bottom. The biometric reader may be configured to capture a particular biometric aspect of a user. Specifically, the biometric reader 450 may be configured to capture one or more of the following: an image of the head and shoulders the shoulders of a user; an iris or other part of an eye of a user; a unique marking on the skin of a user (e.g., fingerprint); a voice or speech sample of a suer; and/or a depth map of a face of a user.

The system 400 may be configured to always prompt a user for biometric features from biometric reader 450. The system 400 may be configured to conditionally prompt a user for biometric features from biometric reader 450. For example, system 400 may validate a user or transaction based solely on auth card 410 and without asking for additional information from the user, such as validating based on performing ACDS regarding the degradations 420. If system 400 determines a validation status that the auth card 410 does not match an existing auth card profile associated with the user, system 400 may respond by instructing biometric reader 450 to perform additional authentication of the user.

The card profile datastore 460 of system 400 may be a logical and/or physical data structure configured to store auth card profiles. For example, the card profile datastore 460 may be a database or other specific computing instance running on a single computer system, such as computer 100. In another example, the card profile datastore 460 may be a collection of storage nodes or storage systems that are abstracted from the user, such as a part of cloud computing environment 50. The card profile datastore 460 may be communicatively coupled to the other components of system 400 by network 430.

The card profile datastore 460 may be a single-purpose data structure that is configured to only store records related to ACDS. For example, the card profile datastore 460 may be a database that contains records for individual users. Each user record may have an associated auth card and included auth card details, such as degradation characteristics (e.g., auth card 410 may have stored auth card degradations 420). The records may also contain historical data about previous degradation characteristics. For example, auth card 410-1 may be a previous state of auth card 410, such as when it was newly issued; auth card 410-2 may be the current state of auth card 410 at a fifth time period after auth card 410-1. Continuing the example, auth card degradation characteristics stored in the card profile datastore 460 may include degradation characteristics from a second time period, a third time period, and a fourth time period. The second through fourth time periods may include degradation details that represent the state of the auth card at three periods of time that are after auth card 410-1 but before auth card 410-2.

In some embodiments, the card profile datastore 460 may be a portion or part of a multi-purpose data structure that is configured to store a plurality of different record types. For example, the card profile datastore 460 may be a first database table that includes card degradation characteristics of auth cards, such as auth card 410. Additional database tables may include stored user data of users, such as employment records, financial records, or the like. As part of performing ACDS, system 400 may operate by retrieving stored user data in response to an access attempt. For example, the user may use auth card 410 to attempt to enter a building of employment, and responsively card reader 440 may read the details for comparison and retrieval of user credentials stored in the stored user data of the second table. Further, system 400 may be configured to retrieve, based on the retrieved user credentials, authentication card profile data from the card profile datastore 460.

The processing subsystem 470 of system 400 may be hardware configured to perform processing related to ACDS, such as to determine the validation status of an authentication card. The processing subsystem 470 may be configured as a computer system, such as computer 100. The processing subsystem 470 may be an abstracted computer system, such as cloud computing environment 50. The processing subsystem 470 may be built into a similar computing device as other components of system 400, such as a single computing device with the card reader 440. The processing subsystem 470 may be built as a separate computing system from other components of the system 400. The processing subsystem 470 may be communicatively coupled to the other components of system 400 by network 430. The processing subsystem 470 may include an image processor 472 and an artificial intelligence component 474.

Processing subsystem 470 of system 400 may operate on authentication cards, such as auth card 410, to generate auth card profiles based on the degradation characteristics that represent the degradations of the auth cards. Processing subsystem 470 of system 400 may also be configured to authenticate attempts to perform transactions through ACDS by determining the validation status based on the current degradation and stored historical degradation characteristics. Specifically, system 400 may operate by scanning auth card 410 at a first time 410-1 and again at a second time 410-2. The first time 410-1 may be before the second time 410-2, state another way, the first time 410-1 may be earlier in time than the second time 410-2. If the auth card 410 is not similar to the stored auth card profile, or if the deviation is beyond a predefined degradation threshold, processing subsystem 470 may flag or indicate that the access is unauthorized. If the auth card 410 is similar to or if the difference is within a predefined degradation threshold, the processing subsystem 470 may update the auth card profile stored in the card profile datastore 460.

The image processor 472 may be a collection of hardware and software, such as an application specific integrated circuit. The image processor 472 may be configured to perform various image analysis techniques. The image analysis techniques may be machine learning and/or deep learning based techniques. For example, the image processor 472 may leverage the artificial intelligence component 474 to perform the machine learning and/or deep learning-based techniques. These techniques may include, but are not limited to, region-based convolutional neural networks (R-CNN), you only look once (YOLO), edge matching, clustering, grayscale matching, gradient matching, invariance models, geometric hashing, scale-invariant feature transform (SIFT), speeded up robust feature (SURF), histogram of oriented gradients (HOG) features, and single shot multibox detector (SSD). In some embodiments, the image processor 472 may be configured to aid in identifying degradation characteristics (e.g., scratches, stains, rips, tears, gashes, smudging, fading).

In some embodiments, objects may be identified using an object detection algorithm, such as an R-CNN, YOLO, SSD, SIFT, Hog features, or other machine learning and/or deep learning object detection algorithms. The output of the object detection algorithm may include one or more identities of one or more respective objects with corresponding match certainties. An image of an auth card, from an image capture device such as card reader 440, may be analyzed for degradations, such as degradations 420 of auth card 410-2. Using a relevant object detection algorithm, an auth card or degradation characteristics of an auth card may be identified.

In some embodiments, features of the objects may be determined by the image processor 472 using a supervised machine learning model built using training data. For example, an image may be input into by the image processor 472 to the artificial intelligence component 474 and various classifications detected within the image can be output. Characteristics such as object material (e.g., metal, plastic, etc.), shape, size, color, and other characteristics (e.g., size of future scratches, patterns of expanded pitting, regions that may become marred) may be output by the artificial intelligence component 474. Further, the identification of objects (e.g., degradations, etc.) can be output as classifications determined. For example, if a user snaps an image of the auth card 410, the image processor 472 may be configured to output an identity of the object (e.g., including the various stored user data 412 on the card) as well as various characteristics of the auth card 410 (e.g., the number of degradation characteristics 420, the shape of degradation characteristics).

In some embodiments, characteristics of objects may be determined by the image processor 472 using photogrammetry techniques. For example, shapes and dimensions of objects may be approximated using photogrammetry techniques. As an example, if a user provides an image of an auth card, the diameter, depth, thickness, etc. of the auth card may be approximated using photogrammetry techniques. For example, upon an initial setup by a user, the processing subsystem 470 may leverage the image processor 472 and may request for the user to identify the stored user data 412 on auth card 410. In some embodiments, characteristics of objects may be identified by referencing an ontology. For example, if an object is identified, the identity of the object may be referenced within an ontology to determine corresponding attributes of the object. The ontology may indicate attributes such as color, size, shape, use, etc. of the object.

Characteristics may include the shapes of objects, dimensions (e.g., height, length, and width) of objects, a number of objects (e.g., plastic cards, fingers, hands, etc.), colors of the object, and/or other attributes of objects. In some embodiments, the output may generate a list including the identity and/or characteristics of objects (e.g., plastic, metal, glass, etc.). In some embodiments, the output may include an indication that an identity or characteristic of an object is unknown. The indication may include a request for additional input data that can be analyzed such that the identity and/or characteristics of objects may be ascertained. In some embodiments, various objects, object attributes, and relationships between objects (e.g., hierarchical relations, direct relations) may be represented within a knowledge graph (KG) structure. Objects may be matched to other objects based on shared characteristics (e.g., skin-tone of a cheek of a person in a picture, letters, numbers, shapes, or other relevant characters that form stored user data 412), relationships with other objects (e.g., various markings that make up stored user data 412), or objects belonging to the same class (e.g., two characters that make up a stored user data 412).

In some embodiments, the artificial intelligence component 474 may execute machine learning on data using one or more of the following example techniques: K-nearest neighbor (KNN), learning vector quantization (LVQ), self-organizing map (SOM), logistic regression, ordinary least squares regression (OLSR), linear regression, stepwise regression, multivariate adaptive regression spline (MARS), ridge regression, least absolute shrinkage and selection operator (LASSO), elastic net, least-angle regression (LARS), probabilistic classifier, naïve Bayes classifier, binary classifier, linear classifier, hierarchical classifier, canonical correlation analysis (CCA), factor analysis, independent component analysis (ICA), linear discriminant analysis (LDA), multidimensional scaling (MDS), non-negative metric factorization (NMF), partial least squares regression (PLSR), principal component analysis (PCA), principal component regression (PCR), Sammon mapping, t-distributed stochastic neighbor embedding (t-SNE), bootstrap aggregating, ensemble averaging, gradient boosted decision tree (GBRT), gradient boosting machine (GBM), inductive bias algorithms, Q-learning, state-action-reward-state-action (SARSA), temporal difference (TD) learning, apriori algorithms, equivalence class transformation (ECLAT) algorithms, Gaussian process regression, gene expression programming, group method of data handling (GMDH), inductive logic programming, instance-based learning, logistic model trees, information fuzzy networks (IFN), hidden Markov models, Gaussian naïve Bayes, multinomial naïve Bayes, averaged one-dependence estimators (AODE), Bayesian network (BN), classification and regression tree (CART), chi-squared automatic interaction detection (CHAID), expectation-maximization algorithm, feedforward neural networks, logic learning machine, self-organizing map, single-linkage clustering, fuzzy clustering, hierarchical clustering, Boltzmann machines, convolutional neural networks, recurrent neural networks, hierarchical temporal memory (HTM), and/or other machine learning techniques.

The processing subsystem 470 may leverage the image processor 472 and the artificial intelligence component 474, to analyze auth cards and to determine validation status of an auth card. Specifically, the image processor 472 may provide image analysis of auth cards, such as auth card 410 upon each access attempt. The image processor 472 may store each record in the card profile datastore 460 and then perform further analysis of a particular access attempt. The processing subsystem 470 may operate by determining whether an access attempt is valid, such as determining a validation status. The processing subsystem 470 may also operate to determine a future state of an auth card, such as by performing machine learning to determine a likely future state of a card, such as the size, placement, and scope of future degradations.

The determination of the validation status by the processing subsystem 470 may also include determining whether the current set of degradation characteristics are in line with a predicted degradation characteristic. Specifically, the artificial intelligence component 474 may be configured to identify and flag, as a validation status, that there is a deviation from an expected or predicted degradation characteristic. If the deviation is beyond a predefined degradation threshold, then the validation status is that the auth card is inauthentic (e.g., a fake, an unauthorized duplicate). The predefined degradation threshold may be a percentage of change in degradation characteristics that are beyond a certain predefined percentage (e.g., a greater than twenty percent growth in scratch 420-2, a loss of definition in region 420-8 that is greater than one standard deviation, a size of smudge 420-6 that indicates growth of the smudge that is greater than the average growth over the last ten scans).

The determination of the validation status by the processing subsystem 470 may also determine whether a particular set of degradation characteristics from a presented authentication card are beyond a threshold based on a trained machine learning model that is operated by the artificial intelligence component 474. The model may be trained based on input that includes any or all of the following factors: patterns of card usage; previous access attempts by users; variations in card degradation of similar auth cards; variations in card degradation of different auth cards; the type of stored data and method of storage of the stored of auth cards; and geographic locations of auth cards. The model may be executed by artificial intelligence component 474 and may determine a risk of an access attempt as part of the validation status. Depending on the level of risk (e.g., low risk, moderate risk, high risk) a security response may be performed by system 400. For example, if an access attempt is received and the validation status is determined as a high risk, the processing subsystem 470 may prompt the user to perform a biometric authentication for the user on the biometric reader 450. If the biometric authentication of the user indicates that the access attempt was in fact from a genuine user, the processing subsystem 470 may update the auth card profile in the profile datastore 460 related to the user.

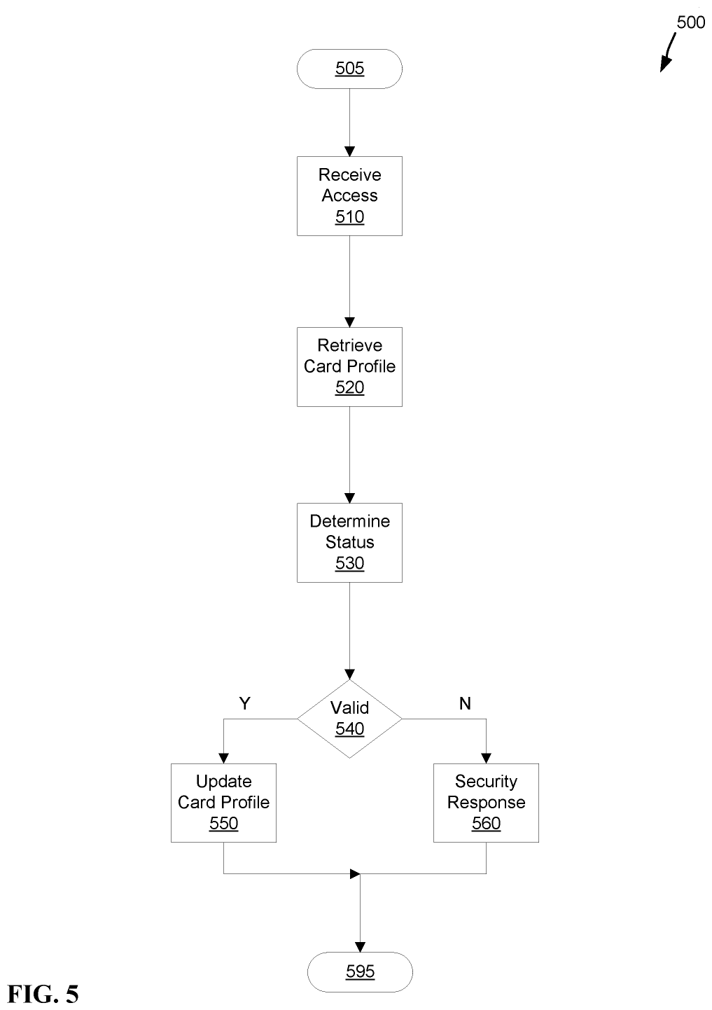

FIG. 5 depicts an example method 500 of authenticated transactions, consistent with some embodiments of the disclosure. Method 500 may generally be implemented in fixed-functionality hardware, configurable logic, logic instructions, etc., or any combination thereof. For example, the logic instructions might include assembler instructions, ISA instructions, machine instructions, machine dependent instructions, microcode, state-setting data, configuration data for integrated circuitry, state information that personalizes electronic circuitry and/or other structural components that are native to hardware (e.g., host processor, central processing unit/CPU, microcontroller, etc.).

Method 500 may begin at 505 when an access attempt is received from a user at 510. The access attempt may be received by a card reader, such as card reader 440. Specifically, the receiving of the access attempt may be that a user swipes an authentication card across a near field communication (“NFC”) receiver to initiate a transaction. For example, an employee may scan an auth card at an NFC reader to attempt to open a security door and the access attempt. The NFC reader may receive a set of stored user data on the auth card as part of receiving the access attempt. The receiving of the access attempt may also include capturing of a current degradation of the auth card. For example, upon the NFC reader being scanned, a user may be prompted to hold their auth card up to a visible light camera for a capture of the current state of degradation of the auth card. In another example, a visible light camera may be positioned adjacent to the NFC reader such that the act of inserting, swiping, or waving the card to trigger the NFC scan also causes a captured of the auth card.

At 520 an authentication card profile may be retrieved. The auth card profile may be retrieved based on the access attempt. Specifically, the user data that is stored on the auth card and is received during the access attempt, may be used to locate one or more user credentials related to the auth card. For example, a security badge of an employee may have an embedded employee serial number that was received at 510, and the serial number may be used to retrieve the auth card profile at 520. The retrieving of the auth card profile may be done by a processing device, such as processing subsystem 470. The auth card profile may contain a set of degradation characteristics. Each characteristic of the set may describe a particular degradation of a given auth card. For example, the security badge may have a gouge along the lower right of the first side that was created over time by the employee inserting the security badge into their pocket with car keys. The degradation of the gouge may be recorded as a first degradation characteristic in the auth card profile.

At 530 a validation status of the authentication card may be determined. The determination of the validation status may be performed based on one or more machine learning or artificial intelligence techniques or image processing techniques. For example, processing subsystem 470 may perform image analysis and machine learning to determine the validation status at 530. The determination of the validation status may be performed by comparing the auth card profile with the current degradation characteristics of the auth card that was swiped as part of the access attempt (that was received at 510). For example, processing subsystem 470 may receive a copy of the current state of auth card 410-2. The processing subsystem 470 may determine a validation status by comparing the current state of the auth card 410-2 to a stored version of the auth card including any previous degradation characteristics that indicate wear and tear. The determination of the validation status may be to determine whether there are changes to the auth card regarding the outward physical appearance that were not present before the access attempt (e.g., more scratches that indicate additional wear, fewer smudges that may indicate a forged authentication card).

At 540: Y if the validation status is that the access attempt was from an authorized user, method 500 continues by updating the auth card profile at 550. Specifically, if the changes were not so many or such to trigger an indication of an unauthorized access attempt, the changes may be recorded. The recorded changes may include updating the authentication card profile with any stored new markings, scratches, changes in brightness or clarity, or pitting or surface texture differences as new degradation characteristics. The updated and new degradation characteristics may be stored with additional details (e.g., the location of the access attempt, the serial and model number of the auth card reader, the time of day of the access attempt, whether a degradation characteristic is new or a change to an existing degradation characteristic).

At 540: N if the validation status is that the access attempt was not from an authorized user, method 500 continues by performing a security response at 560. The security response may be generalized in nature. Specifically, an access denied message may be communicated to a terminal or screen adjacent to the auth card reader. The security response may be related to the first access attempt. Specifically, the security response may include prompting a user for additional authentication factors to validate that they are a genuine user. For example, the security response may be to prompt for and receive a biometric factor from the user, such as a fingerprint. In another example, the security response may be to prompt the user for additional information that could be validated against any user data, such as a security question and corresponding answer.

After the card profile is updated at 550, or after the security response is performed at 560, method 500 may end at 595.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

What is claimed is:

1. A method comprising:
receiving, from a first user, a first access attempt to perform a secure transaction, wherein the secure transaction is related to an authentication card that has a physical exterior;
retrieving, based on the first access attempt, an authentication card profile related to the authentication card of the first user, wherein the authentication card profile describes a set of one or more degradation characteristics, each degradation characteristic of the set of degradation characteristics describes a degradation of the physical exterior of the authentication card;
determining, based on the first access attempt and based on the set of degradation characteristics, a validation status of the authentication card; and
performing, in response to the validation status, a security response related to the first access attempt.

2. The method of claim 1, wherein:
the authentication card includes a set of stored user data of the first user, and
the retrieving the authentication card profile includes:
retrieving, from a user data store and based on the set of stored user data, one or more user credentials of the first user; and
retrieving, based on the user credentials, the authentication card profile.

3. The method of claim 2, wherein the set of stored user data is embedded into an integrated circuit located inside the authentication card.

4. The method of claim 1, wherein the authentication card is selected from the group consisting of a smart card, a magnetic stripe card, a payment system card, and an identification card.

5. The method of claim 1, wherein the degradation of the physical exterior of the authentication card includes at least one scratch of a first physical surface of the authentication card.

6. The method of claim 4, wherein the degradation of the physical exterior of the authentication card includes at least one scratch of a second physical surface of the authentication card.

7. The method of claim 1, wherein the physical exterior of the authentication card includes a set of one or more visual markings of a first physical surface of the authentication card.

8. The method of claim 7, wherein the degradation of the physical exterior includes fading of a first visual marking of the set of visual markings.

9. The method of claim 7, wherein the degradation of the physical exterior includes smudging of a first visual marking of the set of visual markings.

10. The method of claim 1, wherein the degradation of the physical exterior includes a change in reflectivity of a first physical surface of the authentication card.

11. The method of claim 1, wherein the first access attempt includes a current exterior visualization that depicts one or more current degradation characteristics of the physical exterior of the authentication card at the time of the first access attempt.

12. The method of claim 11, wherein the method further comprises:
updating the authentication card profile with the one or more current degradation characteristics of the current exterior visualization of the authentication card.

13. The method of claim 11, wherein the determining the validation status includes comparing the current exterior visualization to the authentication card profile.

14. The method of claim 13, wherein the validation status is that the current exterior visualization deviates from the authentication card profile.

15. The method of claim 14, wherein the deviation is based on a predefined degradation threshold.

16. The method of claim 14, wherein the security response includes denying the first access attempt.

17. The method of claim 14, wherein the security response includes requesting additional authentication factors from the first user.

18. The method of claim 15, wherein the additional authentication factors include one or more biometric features of the first user.

19. A system, the system comprising:
a memory, the memory containing one or more instructions; and
a processor, the processor communicatively coupled to the memory, the processor, in response to reading the one or more instructions, configured to:
receive, from a first user, a first access attempt to perform a secure transaction, wherein the secure transaction is related to an authentication card that has a physical exterior;
retrieve, based on the first access attempt, an authentication card profile related to the authentication card of the first user,
wherein the authentication card profile describes a set of one or more degradation characteristics, each degradation characteristic of the set of degradation characteristics describes a degradation of the physical exterior of the authentication card;
determine, based on the first access attempt and based on the set of degradation characteristics, a validation status of the authentication card; and
perform, in response to the validation status, a security response related to the first access attempt.

20. A computer program product, the computer program product comprising:
one or more computer readable storage media; and
program instructions collectively stored on the one or more computer readable storage media, the program instructions configured to:
receive, from a first user, a first access attempt to perform a secure transaction, wherein the secure transaction is related to an authentication card that has a physical exterior;
retrieve, based on the first access attempt, an authentication card profile related to the authentication card of the first user,
wherein the authentication card profile describes a set of one or more degradation characteristics, each degradation characteristic of the set of degradation characteristics describes a degradation of the physical exterior of the authentication card;
determine, based on the first access attempt and based on the set of degradation characteristics, a validation status of the authentication card; and
perform, in response to the validation status, a security response related to the first access attempt.
